(19) United States
(12) Patent Application Publication
(10) Pub. No.: US 2022/0210353 A1
(43) Pub. Date: Jun. 30, 2022

(54) HIGH DYNAMIC RANGE IMAGE SENSORS

(71) Applicant: SEMICONDUCTOR COMPONENTS INDUSTRIES, LLC, Phoenix, AZ (US)

(72) Inventor: Sergey VELICHKO, Boise, ID (US)

(73) Assignee: SEMICONDUCTOR COMPONENTS INDUSTRIES, LLC, Phoenix, AZ (US)

(21) Appl. No.: 17/137,860

(22) Filed: Dec. 30, 2020

(51) Int. Cl. H04N 5/355; H04N 5/378

(52) U.S. Cl. CPC H04N 5/3559; H04N 5/378

(57) ABSTRACT

An image sensor may include an image sensor pixel array, row control circuitry, and column readout circuitry. Pixels in the image sensor pixel array may each include multiple photosensitive elements disposed around one another. Each pixel may also include first and second in-pixel memory configured to store corresponding overflow charge from first and second photosensitive elements, respectively. The first photosensitive element may be a large photodiode while the second photosensitive element may be a small photodiode. If desired, the large photodiode may be implemented as a set of split but interconnected photodiodes. If desired, each pixel may also include a medium photodiode.

### BACKGROUND

This relates generally to imaging systems and more specifically to image sensors having high dynamic range pixels.

A typical image sensor includes pixels that generate image signals in response to incident light. In some arrangements, each image sensor pixel may include small and large photodiodes useable to extend image dynamic range (e.g., using the large/small photodiode optical ratio).

However, several issues may arise from using these arrangements. As an example, if care is not taken, the respective locations of the small photodiodes and the large photodiodes in the image pixel array can cause color shifts due to cross-talk from the large photodiodes to the small photodiodes of a different color. Additionally, if charge generated by the small photodiode is not effectively added with corresponding charge generated by the large photodiode, low light performance may suffer, and similarly, if the generated charge from one or both photodiodes cannot be effectively read out, there may be other color artifacts in generating the images. Further, it may be difficult to effectively shrink pixels to smaller sizes due to large photodiode and small photodiode capacity drop and the associated large transitional signal-to-noise (SNR) drop, leading to a loss of dynamic range and image artifacts. It is therefore desirable to improve low light performance, dynamic range, SNR transitions, color fidelity of these types of pixels, especially for relatively small pixels.

It is within this context that the embodiments herein arise.

### BRIEF DESCRIPTION OF THE DRAWINGS

FIG. 1 is a diagram of an illustrative imaging system having an image sensor and processing circuitry in accordance with some embodiments.

FIG. 2 is a diagram of an illustrative image sensor having a pixel array and corresponding control and readout circuitry in accordance with some embodiments.

FIG. 3A is a circuit diagram of an illustrative image sensor pixel having high dynamic range functionalities in accordance with some embodiments.

FIG. 3B is a diagram of an illustrative arrangement between two photosensitive elements in the image sensor pixel shown in FIG. 3A in accordance with some embodiments.

FIG. 4 is an electric potential diagram for illustrative elements in the image sensor pixel shown in FIG. 3A in accordance with some embodiments.

FIGS. 5A and 5B are diagrams of illustrative connections between two photosensitive elements in accordance with some embodiments.

FIGS. 6A-6C are diagrams of illustrative split photosensitive elements and associated connections and arrangements in accordance with some embodiments.

FIGS. 7A and 7B are cross-sectional views of an illustrative image sensor pixel of the type described in connection with one or more of FIGS. 3-6 in accordance with some embodiments.

FIG. 8 is an illustrative timing diagram for operating an image sensor pixel of the type shown in FIG. 3A in accordance with some embodiments.

FIG. 9A is a circuit diagram of an illustrative image sensor pixel having high dynamic range functionalities using three types of photosensitive elements in accordance with some embodiments.

FIG. 9B is a diagram of an illustrative arrangement between three photosensitive elements in the image sensor pixel shown in FIG. 9A in accordance with some embodiments.

FIG. 10 is an electric potential diagram for illustrative elements in the image sensor pixel shown in FIG. 9A in accordance with some embodiments.

FIG. 11 is a cross-sectional view of an illustrative image sensor implementing image sensor pixels of the type shown in FIGS. 9 and 10 in accordance with some embodiments.

### DETAILED DESCRIPTION

Electronic devices such as digital cameras, computers, cellular telephones, and other electronic devices may include image sensors that gather incoming light to capture an image (e.g., an image frame). The image sensors may include arrays of image sensor pixels. The pixels in the image sensors may include photosensitive elements such as photosensitive elements that convert the incoming light into image signals. Image sensors may have any number of pixels (e.g., hundreds or thousands or more). A typical image sensor may, for example, have hundreds of thousands or millions of pixels (e.g., megapixels). Image sensors may include control circuitry such as circuitry for operating the image pixels and readout circuitry for reading out image signals corresponding to the electric charge generated by the photosensitive elements.

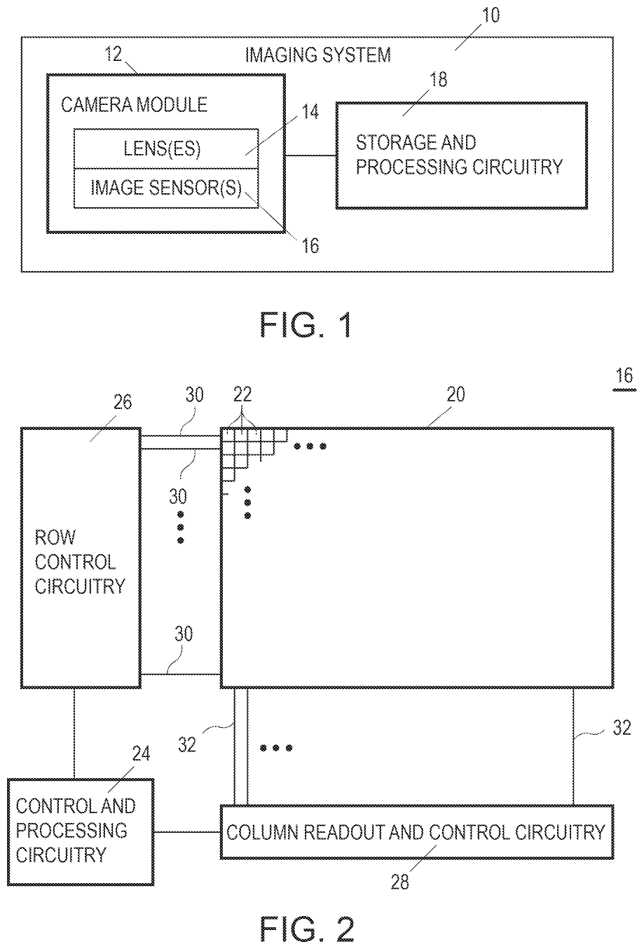

FIG. 1 is a diagram of an illustrative imaging system such as an electronic device that uses an image sensor to capture images. Imaging system 10 of FIG. 1 may be a camera, a cellular telephone, a tablet computer, a webcam, a video camera, a video surveillance system, an automotive imaging system, a video gaming system with imaging capabilities, an augmented reality and/or virtual reality system, an unmanned aerial vehicle system (e.g., a drone), an industrial system, or any other desired imaging system or device that captures digital image data. Camera module 12 (sometimes referred to as an imaging module) may be used to convert incoming light into digital image data. Camera module 12 may include one or more lenses 14 and one or more corresponding image sensors 16. During image capture operations, light from a scene may be focused onto image sensor 16 by lenses 14. Image sensor 16 may include analog-to-digital converter (ADC) circuitry for converting analog pixel signals into corresponding digital image data that is provided to storage and processing circuitry 18.

Storage and processing circuitry 18 may include one or more integrated circuits (e.g., image processing circuits, microprocessors, storage devices such as random-access memory and non-volatile memory, etc.) and may be implemented using components that are separate from the camera module and/or that form part of the camera module. When storage and processing circuitry 18 is included on different integrated circuits than those of image sensors 16, the integrated circuits with circuitry 18 may be vertically stacked or packaged with respect to the integrated circuits with image sensors 16. Image data that has been captured by the camera module may be processed and stored using processing circuitry 18 (e.g., using an image processing engine on processing circuitry 18, using an imaging mode selection engine on processing circuitry 18, etc.). Processed image data may, if desired, be provided to external equipment (e.g., a computer, an external display, or other devices) using wired and/or wireless communications paths coupled to processing circuitry 18.

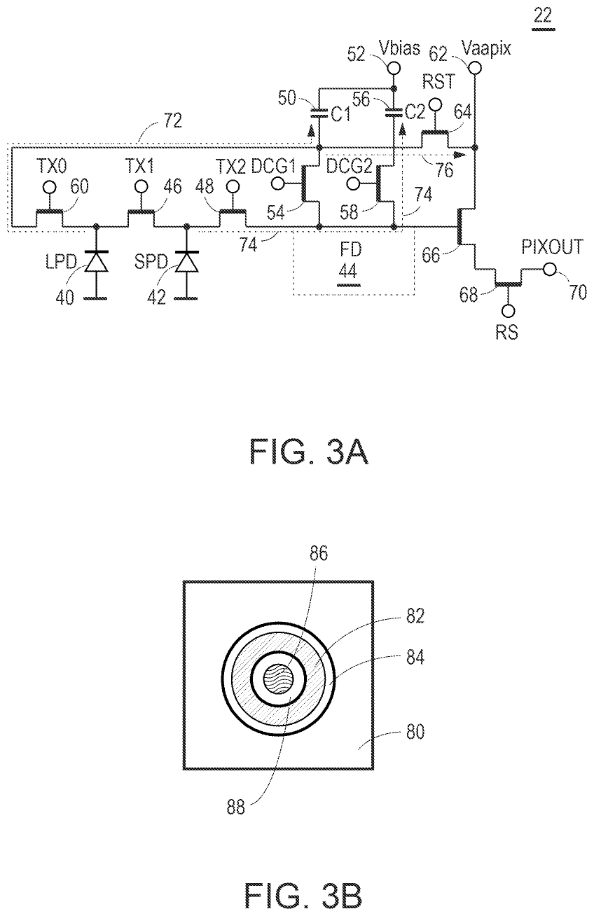

As shown in FIG. 2, image sensor 16 may include pixel array 20 containing image sensor pixels 22 (sometimes referred to herein as image pixels or pixels) arranged in rows and columns, and may include control and processing circuitry 24. Array 20 may contain, for example, hundreds or thousands of rows and columns of image sensor pixels 22. Control circuitry 24 may be coupled to row control circuitry 26 (sometimes referred to as row driver circuitry) and column readout and control circuitry 28 (sometimes referred to herein as column readout circuitry or column control circuitry, or simply readout circuitry when not associated with columns of pixel 22). Row control circuitry 26 may receive row addresses from control circuitry 24 and supply corresponding row control signals such as reset, anti-blooming, row select, charge transfer, dual conversion gain mode, and readout control signals to pixels 22 over row control paths 30. One or more conductive lines such as column lines 32 may be coupled to each column of pixels 22 in array 20. Column lines 32 may be used for reading out (reset level or image level) signals from pixels 22 and for supplying bias signals (e.g., bias currents or bias voltages) to pixels 22. If desired, during pixel readout operations, a pixel row in array 20 may be selected using row control circuitry 26 and a signal generated by each corresponding image pixel 22 in that pixel row can be read out along a respective column line 32.

Column readout circuitry 28 may receive signals (e.g., analog pixel values generated by pixels 22) over column lines 32. Column readout circuitry 28 may include memory circuitry for temporarily storing calibration signals (e.g., reset level signals, reference level signals) and/or image signals (e.g., image level signals) read out from array 20, amplifier circuitry or a multiplexer circuit, analog to digital converter (ADC) circuitry, bias circuitry, latch circuitry for selectively enabling or disabling the column circuitry, or other circuitry that is coupled to one or more columns of pixels in array 20 for operating pixels 22 and for reading out signals from pixels 22. After reading out and/or processing signals from pixel 22, readout circuitry 28 may supply the readout pixel data to control and processing circuitry 24 and/or processor 18 (FIG. 1) for further processing and/or storage.

Pixel array 20 may also be provided with a filter array having multiple (color) filter elements (each corresponding to a respective pixel) which allows a single image sensor to sample light of different colors or sets of wavelengths. As an example, image sensor pixels 22 may be provided with a color filter array having red, green, and blue filter elements, which allows a single image sensor to sample red, green, and blue (RGB) light using corresponding red, green, and blue image sensor pixels arranged in a Bayer mosaic pattern. In other suitable examples, the green pixels in a Bayer pattern may be replaced by broadband image pixels having broadband color filter elements (e.g., clear color filter elements, yellow color filter elements, etc.), or one of the green pixels in a Bayer pattern may be replaced by infrared (IR) image pixels formed under IR color filter elements and/or the remaining red, green, and blue image pixels may also be sensitive to IR light (e.g., may be formed under filter elements that pass IR light in addition to light of their respective colors). These examples are merely illustrative and, in general, filter elements of any desired color and/or wavelength and in any desired pattern may be formed over any desired number of image pixels 22.

Configurations in which pixels 22 are high dynamic range pixels each configured to generate multiple image signals optimized for corresponding light environments (e.g., low light, mid light, high light, etc.) and useable to form a portion of a high dynamic range image are described herein as illustrative examples. In scenarios where pixels 22 are high dynamic range pixels, pixels 22 may generate the multiple image signals based on different corresponding portions of charge generated during the same integration time period (or in some cases, during different integration time periods). If desired, pixels 22 may generate any other suitable image signal in other suitable manners to provide high dynamic range functionalities.

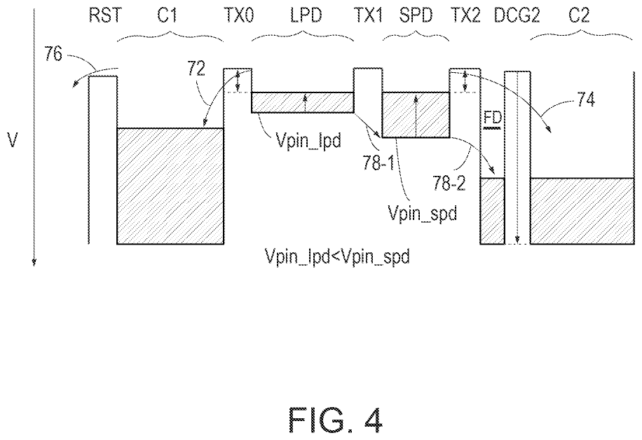

FIG. 3A shows an illustrative pixel 22 that may be used to implement pixels 22 in FIG. 2. As shown in FIG. 3A, pixel 22 includes a first photosensitive element such as photodiode 40 (e.g., a pinned photodiode) and a second photosensitive element such as photodiode 42 (e.g., a pinned photodiode). Each of the two photodiodes may receive incident light over a period of time (e.g., the same integration or exposure time period) and may generate electric charge based on the incident light. Pixel 22 in FIG. 3A also includes a floating diffusion region 44 having an associated charge storage capacity (capacitance).

One or more transfer transistors such as transistors 46 and 48 may couple photodiodes 40 and 42 to floating diffusion region 44. In particular, transistor 46 receiving control signal TX1 couples photodiode 40 to photodiode 42, and transistor 48 reciting control signal TX2 couples photodiode 42 to floating diffusion region 44. These two transfer transistors may be activated to transfer photodiode-generated charge to floating diffusion region 44 for pixel readout operations (e.g., reading out image level signals corresponding to the charge at floating diffusion region 44 from pixel 22).

In the example of FIG. 3A, pixel 22 includes a first charge storage structure (sometimes referred to herein as first in-pixel memory) such as first capacitor 50 having a first terminal coupled to a voltage source 52 (e.g., supplying a fixed or variable voltage signal Vbias) and having a second terminal coupled to floating diffusion region 44 via transistor 54 receiving control signal DCG1. Pixel 22 in FIG. 3A also includes a second charge storage structure (sometimes referred to herein as second in-pixel memory) such as second capacitor 56 having a first terminal coupled to voltage source 52 and having a second terminal coupled to floating diffusion region 44 via transistor 58 receiving control signal DCG2. Photodiode 40 is coupled to capacitor 50 (at the second terminal) via transistor 60 receiving control signal TX0.

The second terminal of capacitor 50 is also coupled to voltage source 62 (e.g., supplying a fixed or variable voltage signal such as a supply voltage Vaapix) via transistor 64 receiving control signal RST. Transistor 64 sometimes referred to herein as reset transistor 64 may connect voltage source 62 to one or more elements in pixel 22 (e.g., capacitor 50 using transistor 64, floating diffusion region 44 using transistors 64 and 54, capacitor 56 using transistors 64, 54, and 58, photodiode 40 using transistors 64 and 60, photodiode 42 using transistors 64, 54, and 48, etc.) to reset the one or more elements to a reset voltage level (e.g., supply voltage Vaapix). In particular, the reset level charge at the floating diffusion region (e.g., after activating transistors 64 and 54) may be read out as reset level signals.

To enable pixel readout operations, pixel 22 in FIG. 3A includes a source follower transistor 66 and a row select transistor 68. Source follower transistor has a gate or control terminal coupled to floating diffusion region 44, a first source-drain terminal (e.g., one of a source or drain terminal) coupled to voltage source 62, and a second source-drain terminal (e.g., the other one of the source or drain terminal) coupled to row select transistor 68. When control signal RS for row select transistor 68 is asserted (e.g., during a pixel row readout operation when reset and/or image level signals from pixels in a given row that includes pixel 22 are being read out), pixel output signal PIXOUT may be passed onto pixel output path 70 (e.g., coupled to column line 32 in FIG. 2). Pixel output signal PIXOUT may be an output signal having a magnitude that is proportional to the amount of charge at floating diffusion region 44 (e.g., may represent a reset level signal when the amount of charge at floating diffusion region 44 is associated with reset level charge or may represent an image level signal when the amount of charge at floating diffusion region 44 is associated with image level or photodiode-generated charge).

To generate different portions of charge optimized for different light environments, photodiodes 40 and 42 may be of different sizes (e.g., having an optical ratio therebetween not equal to one, having different light sensitivity properties, having different charge storage capacities, different well sizes, different photosensitive areas or volumes, etc.). In the example of FIG. 3A, photodiode 40 may be a larger photodiode LPD (e.g., may have a greater charge storage capacity) than photodiode 42 (e.g., smaller photodiode SPD). In other words, the optical ratio of photodiode 40 to photodiode 42 may be greater than one. These examples are merely illustrative. If desired, photodiodes 40 and 42 may be implemented in other suitable manners.

FIG. 3B is a diagram of illustrative photodiodes having different sizes such as photodiodes 40 and 42 in FIG. 3A and their illustrative configurations with respect to each other. In the plan view of FIG. 3B, a first larger photosensitive area 80 associated with a larger photodiode (e.g., photodiode 40 in FIG. 3A) may laterally surround a second smaller photosensitive area 82 associated with a smaller photodiode (e.g., photodiode 42 in FIG. 3A). In particular, in this example, given a same depth (e.g., a dimension into and/or out of the page) associated with photosensitive areas 80 and 82, photodiode 40 may be associated with a larger photosensitive volume and therefore a large storage capacity than photodiode 42. Photosensitive areas 80 and 82 may be separated by one or more isolation structures 84 (e.g., backside deep trench isolation structures). Also shown in FIG. 3B, area 86 may be associated with a floating diffusion region (e.g., floating diffusion region 44 in FIG. 3A) is nested within photosensitive areas 82 and 80. Transistor 88 (e.g., transistor or gate structures such as transistor 48 in FIG. 3A) may be coupled between photosensitive area 82 and floating diffusion region area 86.

The configuration shown in FIG. 3B is merely illustrative. If desired, photosensitive areas or volumes may generally have any suitable shape (e.g., rectangular outlines, polygonal outlines, curved outlines, irregular outlines, etc.). If desired, one photosensitive area or volume may only partially surround (e.g., along one or more sides, along or more curves, without completely laterally surrounding, etc.) another photosensitive area or volume and/or may generally be disposed around (e.g., near) the other photosensitive area or volume. If desired, a floating diffusion region area, and isolation structures may be disposed at any suitable locations (e.g., not necessarily nested within one or more photosensitive elements at one or more cross-sections). Some elements (e.g., transistors) in pixel 22 in FIG. 3A are omitted from FIG. 3B for the sake of clarity (e.g., to not unnecessarily obscure the embodiments described by FIG. 3B).

Referring back to FIG. 3A, capacitors 50 and 52 may be configured to receive and store overflow charge (e.g., overflow portions of charge generated by photodiodes 40 and 42 and separated from the remaining charge generated by photodiodes 40 and 42). In particular, overflow charge from photodiode 40 may be passed along the path indicated by dashed arrow 72 (e.g., through transistor 60) to the second terminal of capacitor 50. Overflow charge from photodiode 42 may be passed along the path indicated by dashed arrow 74 (e.g., through transistor 48, floating diffusion region 44, and transistor 58) to the second terminal of capacitor 56). In other words, capacitor 50 or C1 may serve as a first in-pixel memory for photodiode 40 (e.g., overflow charge from photodiode 40) and capacitor 56 or C2 may serve as a second in-pixel memory for photodiode 42 (e.g., overflow charge from photodiode 42). Additionally, the path indicated by dashed arrow 76 (e.g., through transistor 64) serves as an anti-blooming path for capacitor 50 storing overflow charge from photodiode 40 (e.g., the larger photodiode in pixel 22).

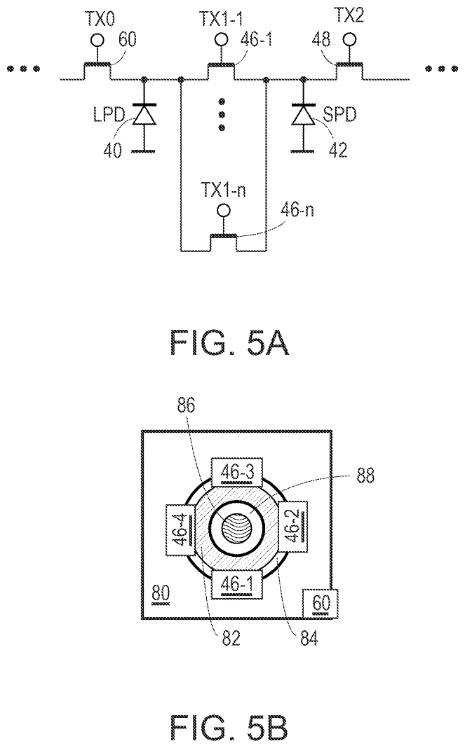

FIG. 4 is an illustrative electric potential diagram for charge storage elements and corresponding transistors in pixel 22 in FIG. 3A. As shown in FIG. 4, large photodiode LPD (e.g., corresponding photodiode 40 in FIG. 3A) is associated with a charge storage well having a pinned potential at voltage Vpin_1pd. A potential barrier (e.g., associated with transistor 60 in FIG. 3A) separates photodiode LPD from capacitor C1 (e.g., corresponding capacitor 50 in FIG. 3A). Control signal TX0 may be modulated to lower the potential barrier to an intermediate level (e.g., a partially asserted level between a fully asserted level and a deasserted level). The lowered potential barrier may cause a portion of charge in excess of the lowered potential barrier (e.g., overflow charge or an overflow portion of charge) from photodiode LPD to flow into capacitor C1 as indicated by arrow 72 (e.g., illustrating an overflow path). If the stored charge at capacitor C1 is in excess of the potential barrier controlled by control signal RST (e.g., associated with transistor 64 in FIG. 3A), the excess charge may leave the pixel via anti-blooming path 76 over the potential barrier.

As further shown in FIG. 4, small photodiode SPD (e.g., corresponding photodiode 42 in FIG. 3A) is associated with a second charge storage well having a pinned potential at voltage Vpin_spd. A first potential barrier (e.g., associated with transistor 48 in FIG. 3A) separates photodiode SPD from floating diffusion region FD (corresponding to floating diffusion region 44 in FIG. 3A) and a second potential barrier (e.g., associated with transistor 58 in FIG. 3A) separates floating diffusion region FD from capacitor C2 (e.g., corresponding to capacitor 56 in FIG. 3A). Control signal TX2 may similarly be modulated to lower the first potential barrier to an intermediate level (while control signal DCG2 maintains a lowered second potential barrier between floating diffusion region FD and capacitor C2). The lower potential barriers may cause a portion of charge in excess of the lowered first potential barrier (e.g., overflow charge or an overflow portion of charge) from photodiode SPD to flow into capacitor C2 as indicated by arrow 74 (e.g., illustrating an overflow path).

As shown in FIG. 4, the pinned potential voltage Vpin_spd for photodiode SPD may be at a higher potential than (e.g., may be greater than) the pinned potential voltage Vpin_1pd photodiode LPD. This may allow for effect charge transfer from photodiode LPD to photodiode SPD (e.g., during a readout operation) with little time delay. Arrows 78-1 and 78-2 show an illustrative readout path for charge at photodiode LPD that passes through photodiode SPD to floating diffusion region FD (e.g., when control signals TX1 and TX2 are fully deasserted).

If desired, photodiodes 40 and 42 in FIG. 3A may be coupled (e.g., connected) to each other using more than one transistor (e.g., an ‘n’ number of transistors, n being greater than one) coupled in parallel. This may allow for more efficient (e.g., faster, more accurate, etc.) charge transfer from photodiode 40 to photodiode 42 than in configuration where one transistor (e.g., transistor 46 in FIG. 3A) is used.

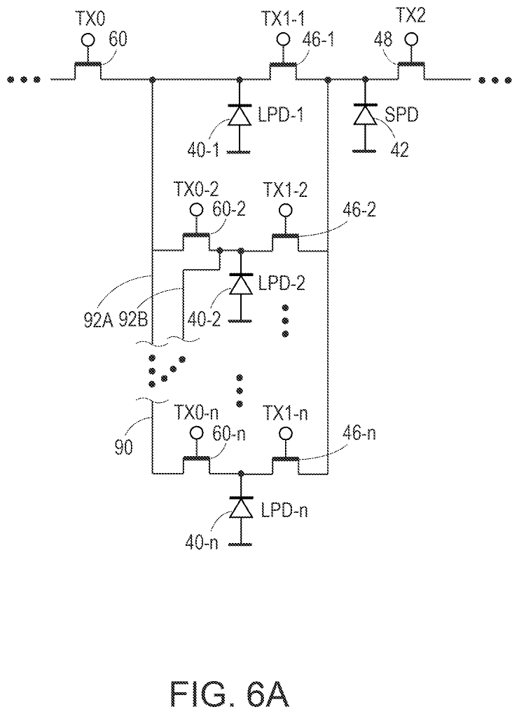

FIG. 5A is a circuit diagram of an illustrative configuration in which two photodiodes such as photodiodes 40 and 42 in FIG. 3A are coupled to each other using n transistors coupled in parallel, where n is greater than one. As shown in FIG. 5A, transistors 46-1, . . . , 46-n may be coupled in parallel between photodiodes 40 and 42. Each of transistors 46 (referring to transistors 46-1, . . . , 46-n, collectively) may receive a corresponding control signal TX1 (e.g., a corresponding one of control signals TX1-1, . . . , TX1-n). Photodiode 40 may still be coupled to the remaining portion of pixel 22 (FIG. 3A) via transistor 60, and photodiode 42 may still be coupled to the remaining portion of pixel 22 (FIG. 3A) via transistor 48.

FIG. 5B is a diagram layout of transistors 46 and 60 in FIG. 5A (or in FIG. 3A) disposed in an illustrative manner with respect to photosensitive areas corresponding to photodiodes 40 and 42 (e.g., in FIG. 3A or 5A). In the plan view of FIG. 5B, four transistors 46 (e.g., transistors 46-1, 46-2, 46-3, and 46-4) are shown as an illustrative example. If desired, any suitable number of transistors 46 may be used (e.g., one transistor 46 in the configuration of FIG. 3A or n number of transistors 46 in the configuration of FIG. 5A). In the example of FIG. 5B, transistors 46 each overlap photosensitive areas 80 and 82, and one or more isolation structures 84 separating photosensitive area 80 (corresponding to photodiode 40) and photosensitive area 82 (corresponding to photodiode 42) and couple (e.g., connect) photosensitive area 80 to photosensitive area 82. Transistor 60 overlaps photosensitive area 80 and couples photosensitive area 80 to a capacitor storage node (e.g., the second terminal of capacitor 50 in FIG. 3A). The configuration shown in FIG. 5B is merely illustrative. If desired, the elements in pixel 22 (in FIG. 3A or in FIG. 5A) may be implemented in any suitable manner.

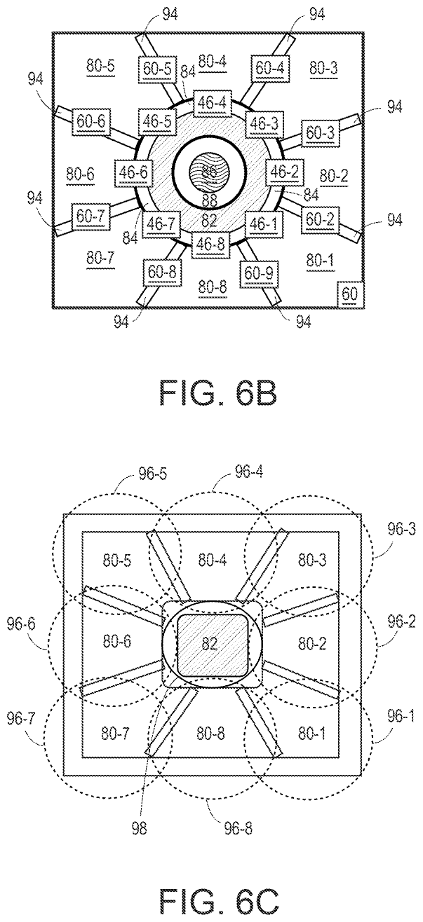

To improve large photodiode capacitance, a large photodiode (e.g., photodiode 40 in FIG. 3A or 5A, a photodiode having photosensitive area 80 in FIG. 3B or 5B, etc.) may be implemented as a series of smaller inter-connected photodiodes (e.g., photosensitive areas or volumes). FIG. 6A is a circuit diagram of an illustrative configuration in which a large photodiode such as photodiode 40 in FIG. 3A or in FIG. 5A is formed from multiple photodiodes.

As shown in FIG. 6A, instead of a single large photodiode 40, a pixel (e.g., pixel 22 of the type in FIG. 2 and/or FIG. 3A) can include multiple photodiodes 40 (referring to photodiodes 40-1, 40-2, . . . 40-n, collectively) to implement a single large photodiode. These photodiodes 40 may be two photodiodes, three photodiodes, more than three photodiodes, eight photodiodes, or any other suitable number of photodiodes. Each of photodiodes 40 may be coupled to small photodiode 42 via a corresponding transistor 46 (e.g., a corresponding one of transistors 46-1, 46-2, . . . , 46-n). Additionally, photodiodes 40 may be coupled to each other using a corresponding transistor 60 (e.g., a corresponding one of transistors 60-2, . . . , 60-n). Photodiode 40s may still be coupled to the remaining portion of pixel 22 (FIG. 3A) via transistor 60, and photodiode 42 may still be coupled to the remaining portion of pixel 22 (FIG. 3A) via transistor 48.

In the example of FIG. 6A, a first photodiode 40-1 is coupled directly to transistor 60 (e.g., transistor 60 in FIG. 3A or 5A used to connect the set of photodiodes 40 to capacitor 50 and other elements in pixel 22 in FIG. 3A). A second photodiode 40-2 is coupled to transistor 60 and photodiode 40-1 via transistor 60-2 controlled by control signal TXO-2. An additional photodiode 40-n is coupled to transistor 60 and photodiode 40-1 directly via transistor 60-n controlled by control signal TXO-n (in a configuration in which path 90 is coupled to path 92A) and/or indirectly via multiple transistors such as via transistor 60-n and one or more of transistors 60-(n-1), 60-(n-2), . . . , 60-2 (in a configuration in which path 90 is coupled to path 92B). In other words, photodiodes 40 may form a chain of (series-) sequentially-connected and/or parallel connected photodiodes. If desired, additional transistors may be provided for one or more of photodiodes 40 to form the desired series or parallel interconnections. If desired, control signals TXO, TXO-2, TXO-3, . . . , TXO-n may be connected together, and control signals TX1-1, TX1-2, . . . , TX1-n may be connected together.

FIG. 6B is a diagram of illustrative split photodiodes (e.g., photodiodes 40 in FIG. 6A) used to implement a large photodiode such as photodiode 40 (e.g., in FIG. 3A or 5A) and their corresponding interconnections. In the example of FIG. 6B, a continuous photosensitive area 80 or the corresponding photosensitive volume associated with the large photodiode 40 (e.g., in the example of FIG. 5B) is split into eight separate photosensitive areas 80-1, 80-2, . . . , 80-8 (each associated with a small photodiode in FIG. 6A that collectively with the other photodiodes form the large photodiode 40). This is merely illustrative. If desired, photosensitive area 80 may be split into any suitable number of areas.

As shown in FIG. 6B, each of the split photosensitive areas 80 (referring to photosensitive areas 80-1, . . . , 80-8, collectively) is separated from its neighboring or adjacent photosensitive area by one or more corresponding isolation structures 94 (e.g., backside deep trench isolation structures). Each of the split photosensitive areas 80 uses a corresponding transistor 46 that overlaps one or more isolation structures 84 to connect that split photosensitive area 80 to photosensitive area 82 for the small photodiode (e.g., photodiode 42 in FIG. 6A). While one of the split photosensitive areas 80 (e.g., photosensitive area 80-1) overlaps transistor 60 and uses transistor 60 to directly couple to a capacitor storage node (e.g., the second terminal of capacitor 50 in FIG. 3A), the remaining split photosensitive areas 80 (e.g., photosensitive areas 80-2, . . . , 80-8) may be coupled to transistor 60 via one or more corresponding transistors 60-2, . . . , 60-9 and any intervening photosensitive areas 80.

The configurations shown in FIGS. 6A and 6B are merely illustrative. If desired, one or more of (e.g., all of) transistors 60-2, . . . , 60-n in FIG. 6A (e.g., transistors 60-2, . . . , 60-9 in FIG. 6B) may be replaced with corresponding conductive implants to form the inter-photodiode connections. In such a manner, each split photosensitive element 80 may be coupled to transistor 60 without any intervening transistors.

FIG. 6C is a diagram of an illustrative microlens configuration that overlaps the split photosensitive areas (e.g., areas 80 in FIG. 6B forming photodiodes 40 in FIG. 6A) implementing the large photodiode and the photosensitive area (e.g., area 82 in FIG. 6B forming photodiode 42 in FIG. 6A) implementing the small photodiode. Some elements (e.g., transistors) may be omitted from FIG. 6C for the sake of clarity.

As shown in FIG. 6C, each of the split photosensitive areas 80 (collectively for a large photodiode) has its dedicated microlens 96 (e.g., a gapless microlens). As an example, microlens 96-1 may substantially overlap photosensitive area 80-1 (e.g., overlap photosensitive area 80-1 more than any of the other split photosensitive areas 80). Other microlenses 96 may each be disposed in an analogous manner relative to the corresponding split photosensitive area. Each of microlenses 96 may be of the same size, same type, and generally be formed in the same manner. As further shown in FIG. 6C, photosensitive area 82 (for a small photodiode) has its own dedicated microlens 98, which may have a smaller size than each of microlenses 96. If desired, microlens 98 may be omitted (e.g., no microlens overlaps photosensitive area 82).

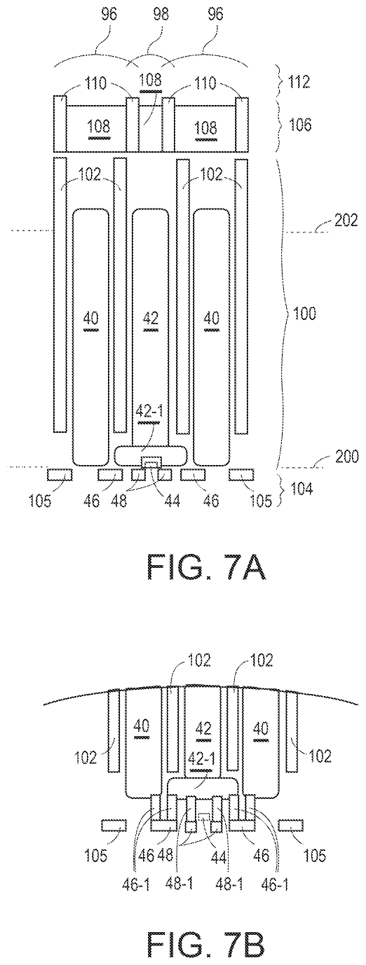

FIG. 7A is a cross-sectional view of an illustrative implementation of an image sensor pixel and corresponding elements described in connection with one or more of FIGS. 3-6. In particular, the cross-sectional view of FIG. 7A may be illustrative of different embodiments described herein. In a first example related to FIG. 3B, the plan view of FIG. 3B for an illustrative image sensor pixel may be taken along the plane perpendicular to the page of FIG. 7A that includes dashed line 200. In a second example related to FIG. 5B, the plan view of FIG. 5B for an illustrative image sensor pixel (e.g., having a single integral large photosensitive volume to implement the large photodiode) may similarly be taken along the plane perpendicular to the page of FIG. 7A that includes dashed line 200, while also including overlapping metal layers forming gates and transistors. In a third example related to FIG. 6B, the plan view of FIG. 6B for an illustrative image sensor pixel (e.g., having multiple split photosensitive volumes to implement the large photodiode) may be similarly taken along the plane perpendicular to the page of FIG. 7A that includes dashed line 200, while also including overlapping metal layers forming gate lines and transistors. In the third example, the plan view of FIG. 6C for the illustrative image sensor pixel may be taken along the plane perpendicular to the page of FIG. 7A that includes dashed line 202, while also including overlapping microlens structures. These examples are merely illustrative of how FIG. 7A can be used to show different illustrative image sensor pixels in connection with FIGS. 3-6.

As shown in FIG. 7A, the image sensor pixel may include photodiodes 40 and 42 formed in a substrate portion 100 (e.g., implemented within a semiconductor substrate). The two portions of photodiode 40 (e.g., to the left and right of photodiode 42) in FIG. 7A may be two separate photodiode portions (e.g. similar to the configuration in FIG. 6B) or may form a single integral photodiode portion (e.g., similar to the configuration in FIG. 3B or 5B). In configurations with separate photodiode portions for photodiode 40, photodiode 40 may exhibit increased linear full-well capacity due to sidewall capacities of the multiple photodiode portions. Photodiode 40 and photodiode 42 (and if suitable, split photodiode portions implementing photodiode 40) may be separated from each other using one or more corresponding isolation structures such as (backside) deep trench isolation structures 102 embedded in substrate portion 100 between photosensitive volumes.

In the example of FIG. 7A, a portion of photodiode 42 (labeled 42-1) extends beneath (e.g., extends over or overlaps) isolation structure 102. This may help increase the well capacity of photodiode 42 and may help ensure that the pinned potential voltage of photodiode 42 is greater than the pinned potential voltage of photodiode 40. The photodiode portion 42-1 may surround floating diffusion region 44 (e.g., separated from each other by one or more isolation structures or potential barriers).

Metal and dielectric layers may be formed in stack portion 104 on substrate portion 100. In particular, as shown in FIG. 7A, gates for transistors such as transistors 46 and 48 are formed from a metal layer in stack portion 104. Transistors 46 may be separate transistors 46 each connecting a split photodiode portion of photodiode 40 or an integral photodiode 40 to photodiode 42. Transistor 48 may connect photodiode 42 to floating diffusion region 44. If desired, the metal layer in stack portion 104 may form other peripheral gate structures 105.

A color filter portion 106 and a microlens portion 112 may be disposed over photodiodes 40 and 42. As shown in FIG. 7A, a smaller microlens 98 in portion 112 may overlap photodiode 42, while larger microlenses 96 in portion 112 may overlap photodiodes 40 (e.g., implemented with a continuous photodiode or split photodiode portions). Accordingly, color filter array composite grid 110 in portion 106 may have openings that are aligned with the sizes of the overlapping microlens. As an example, the opening in grid 110 underneath or overlapping microlens 98 may be smaller than the openings in grid 110 underneath or overlapping microlens 96. The same type of color filter elements (e.g., of the same color and/or for the same wavelengths) may be disposed within the three openings in grid 110 for the same pixel.

If desired, gates for transistors 46 and 48 may include vertical portions 46-1 and 48-1 as shown in FIG. 7B. By the pixel providing vertical gate structures for transistors 46 and 48, peripheral gate structures 105 may be provided with more space and dark current for the photodiodes and other noise may be decreased.

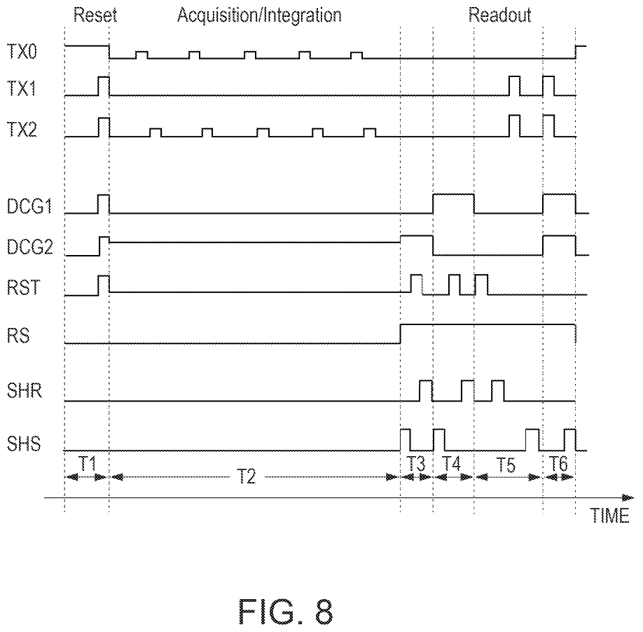

FIG. 8 is an illustrative timing diagram for operating an image sensor pixel of the type described in connection with FIG. 3A. The timing diagram of FIG. 8 may be adapted accordingly for the configurations (e.g., modifications) described in connection with FIGS. 5A and 6A. Configurations in which control circuitry (e.g., row control circuitry 26 in FIG. 2) uses the timing diagram of FIG. 8 to operate pixel 22 of FIG. 3 are described herein as examples.

As shown in FIG. 8, control circuitry (e.g., row control circuitry 26 in FIG. 2) may operate the pixel (e.g., pixel 22 of FIG. 3) during a reset time period T1, during which control signals TXO, TX1, TX2, DCG1, DCG2, and RST are asserted to reset photodiodes 40 and 42, capacitor storage terminals for capacitors 50 and 56, floating diffusion region 44 (FIG. 3A) to a reset voltage level (e.g., supply voltage Vaapix).

After the end of the reset time period T1, the control circuitry may operate the pixel during an acquisition or integration time period T2 during which photodiodes 40 and 42 generate image charge in parallel in response to incident light. During acquisition time period T2, the control circuitry may periodically (and partially) assert control signal TX0 to lower the potential barrier between photodiode 40 and capacitor 50, thereby providing an overflow path indicated by arrow 72 (FIG. 3A) through which overflow charge from photodiode 40 flows to and is accumulated at capacitor 50. Similarly, the control circuitry may periodically (and partially) assert control signal TX2 to lower the potential barrier between photodiode 42 and floating diffusion region 44 and may assert control signal DCG2 to a suitable level to lower the potential barrier between floating diffusion region 44 and capacitor 56 (e.g., provide charge-sharing), thereby providing an overflow path indicated by arrow 74 (FIG. 3A) through which overflow charge from photodiode 42 flows to and is accumulated at capacitor 56. Throughout acquisition time period T2, the control circuitry may assert control signal RST to a suitable level to perform anti-blooming functions. If desired, the control circuitry may also vary the bias voltage (signal Vbias in FIG. 3A) between time periods T1 and T2 (e.g., provide a smaller bias voltage during time period T2) to decrease dark current and noise.

In this manner, at the end of acquisition time period, there may be first overflow charge from photodiode 40 stored at capacitor 50, second overflow charge from photodiode 52 stored at capacitor 56, first (non-overflow or remaining) charge stored at photodiode 40, and second (non-overflow or remaining) charge stored at photodiode 42. Thereafter, the control circuitry may operate the pixel during the readout time period T3 to T6 (e.g., the beginning of time period T3 to the end of time period T6) to read out different portions of charge. Throughout the readout time period, the control circuitry may assert control signal RS.

In particular, during time period T3, the control circuitry may assert control signal DCG2 to connect capacitor 56 to floating diffusion region 44. The overflow charge at capacitor 56 may thereafter be read out as a first image level signal by asserting control signal SHS (e.g., controlling readout circuitry to sample the first image level signal). After the overflow charge at capacitor 56 has been read out, the control circuitry may assert control signal RST to reset floating diffusion region 44 and capacitor 56 to a reset level voltage. This reset level voltage may subsequently be read out as a first reset level signal by asserting control signal SHR (e.g., controlling readout circuitry to sample the first reset level signal). In other words, the first image level readout may be performed in a double sampling mode of operation (e.g., in view of the first reset level readout).

During time period T4, the control circuitry may assert control signal DCG1 to connect capacitor 50 to floating diffusion region 44. The overflow charge at capacitor 50 may thereafter be read out as a second image level signal by asserting control signal SHS (e.g., controlling readout circuitry to sample the second image level signal). After the overflow charge at capacitor 50 has been read out, the control circuitry may assert control signal RST to reset floating diffusion region 44 and capacitor 50 to a reset level voltage. This reset level voltage may subsequently be read out as a second reset level signal by asserting control signal SHR (e.g., controlling readout circuitry to sample the second reset level signal). In other words, the second image level readout may be performed in a double sampling mode of operation (e.g., in view of the second reset level readout).

During time period T5, the control circuitry may assert control signal RST to reset floating diffusion region 44 while deasserting control signals DCG1 and DCG2 to reset floating diffusion region 44 to a reset level voltage. This reset level voltage may subsequently be read out as a third reset level voltage by asserting control signal SHR (e.g., controlling readout circuitry to sample the third reset level signal). After the reset level voltage has been readout, the control circuitry may assert control signals TX1 and TX2 to transfer the (non-overflow) charge at photodiodes 40 and 42 (e.g., the combined charge at photodiodes 40 and 42) to floating diffusion region 44. The combined charge may be read out as a third image level signal by asserting control signal SHS (e.g., controlling readout circuitry to sample the third image level signal). This third image level signal may be a high conversion gain signal, and in combination with the third reset level signal readout, may be read out as a correlated double sampling readout.

During time period T6, the control circuitry may again assert control signals TX1 and TX2, while the control circuitry also asserts control signal DCG1 and DCG2. This time, the combined charge may be read out as a low conversion gain signal (e.g., a fourth image level signal) by asserting control signal SHS (e.g., controlling readout circuitry to sample the fourth image level signal). This low conversion gain signal may similarly be readout as a correlated double sampling readout (e.g., in view of the third reset level signal readout).

Based on the operation described in connection with FIG. 8, four different image signals may be obtained (e.g., after correlating with corresponding reset level signals, after performing analog-to-digital conversion, etc.). These four image signals may be suitable processed by downstream processing circuitry (e.g., by linearization logic circuitry) to arrive at the corresponding output optimized for the corresponding light environment (e.g., a modified linear combination of the four image signals). Advantageously, by using an illustrative pixel of the type in FIG. 3A (e.g., implemented with modifications indicated in FIGS. 5A and/or 6A) and operating the pixel using the illustrative timing diagram of FIG. 8, the image sensor exhibits improved low light performance (e.g., using a single combined readout from photodiodes 40 and 42 without time delay during time period T5), and improvements in max SNRs of different light regimes and SHR transitions (e.g., due to improved photodiodes with overflow capacities), while maintaining flicker-free performance and other desirable characteristics. These advantages are maintained even with reduced pixel sizes and high temperature operations.

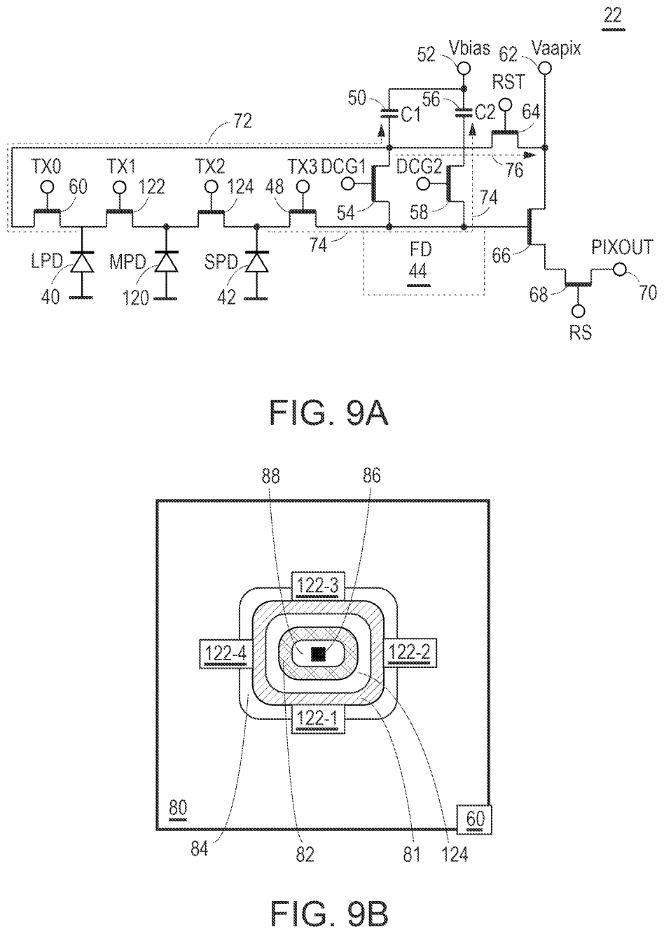

If desired, pixel 22 in FIG. 3A (e.g., with or without the modifications in FIGS. 5A and 6A) may further include an additional photodiode (e.g., a medium photodiode in addition to the small photodiode and large photodiode described in connection with FIGS. 3A and 3B). FIG. 9A is a circuit diagram of an illustrative configuration for pixel 22 in which pixel 22 in FIG. 3A is implemented with the additional photodiode. In particular, as shown in FIG. 9A, photodiode 40 (e.g., the largest photodiode in pixel 22) may still be coupled to transistor 60 and through transistor 60 be coupled to other elements in pixel 22 (e.g., capacitor 50, in the same manner as described in connection with FIG. 3A), and similarly, photodiode 42 (e.g., the smallest photodiode in pixel 22) may still be coupled to transistor 48 and through transistor 48 be coupled to other elements in pixel 22 (e.g., floating diffusion region 44, in the same manner as described in connection with FIG. 3A). Capacitor 50 may still receive overflow charge from photodiode 40, and capacitor 56 may still receive overflow charge from photodiode 40.

Additionally, in the example of FIG. 9A, pixel 22 includes photodiode 120, which may be a medium photodiode. Photodiodes 40, 120, and 42 may be of progressively larger sizes (e.g., having progressively increased optical properties, having progressively increased light sensitivities, having progressively larger charge storage capacities, well sizes, or photosensitive areas or volumes, etc.), with photodiode 40 being the largest, photodiode 120 being medium sized, and photodiode 42 being the smallest. In other words, the optical ratio of photodiode 40 to photodiode 120 may be greater than one, and the optical ratio of photodiode 120 to photodiode 42 may be greater than one. These examples are merely illustrative. As shown in FIG. 9A, photodiode 120 is coupled to photodiode 40 via transistor 122 and is coupled to photodiode 42 via transistor 124. By including photodiode 120, pixel 22 in FIG. 9A may be configured to exhibit increased dynamic range relative to pixel 22 in FIG. 3A because of the larger optical ratio between photodiode 40 and 42.

FIG. 9B is a diagram of three illustrative photodiodes having different sizes such as photodiodes 40, 120, and 42 in FIG. 9A and their illustrative configurations with respect to each other. In the plan view of FIG. 9B, a first larger photosensitive area 80 associated with a large photodiode (e.g., photodiode 40 in FIG. 9A) may laterally surround a second smaller photosensitive area 81 associated with a medium photodiode (e.g., photodiode 120 in FIG. 9A), which may laterally surround a third smallest photosensitive area 82 associated with a small photodiode (e.g., photodiode 42 in FIG. 9A). Photosensitive areas 80 and 81 may be separated by one or more isolation structures 84 (e.g., backside deep trench isolation structures). One or more transistors 122 may overlap isolation structures 84 to connect photosensitive areas 80 and 81. Similarly, photosensitive areas 81 and 82 may be separated by one or more additional isolation structures. One or more transistors 124 may overlap the additional isolation structures to connect photosensitive areas 81 and 82. Also shown in FIG. 9B, area 86 may associated with a floating diffusion region (e.g., floating diffusion region 44 in FIG. 9A) is nested within photosensitive areas 82, 81, and 80. One or more transistors 88 (e.g., transistor or gate structures such as transistor 48 in FIG. 9A) may be coupled between photosensitive area 82 and floating diffusion region area 86.

The configuration shown in FIG. 9B is merely illustrative. If desired, photosensitive areas or volumes may generally have any suitable shape (e.g., rectangular outlines, polygonal outlines, curved outlines, irregular outlines, etc.). If desired, one photosensitive area or volume may only partially surround (e.g., along one or more sides, along or more curves, without completely laterally surrounding, etc.) another photosensitive area or volume and/or may generally be disposed around (e.g., near) the other photosensitive area or volume. If desired, a floating diffusion region area, isolation structures, and transistors may be disposed at any suitable locations (e.g., not necessarily nested within one or more photosensitive elements at one or more cross-sections).

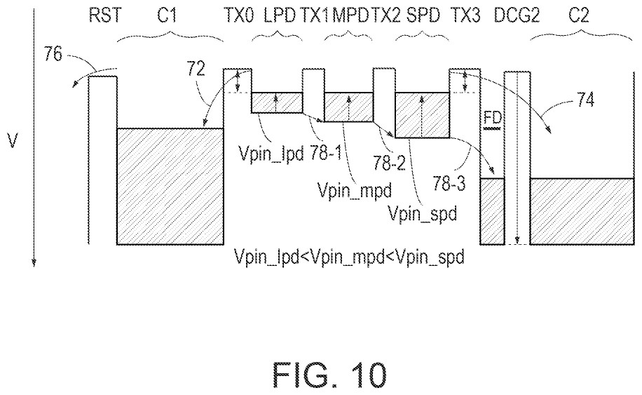

FIG. 10 is an illustrative electric potential diagram for charge storage elements and corresponding transistors in pixel 22 in FIG. 9A. The electric potential diagram of FIG. 10 may have similar elements as the electric potential diagram of FIG. 4. Additionally, the electric potential diagram of FIG. 10 includes medium photodiode MPD (e.g., corresponding to photodiode 120 in FIG. 9A) associated with its corresponding charge storage well having a pinned potential at voltage Vpin_mpd. A potential barrier (e.g., associated with transistor 122 receiving control signal TX1 in FIG. 9A) separates photodiode MPD from photodiode LPD (corresponding to photodiode 40 in FIG. 9A), and another potential barrier (e.g., associated with transistor 124 receiving control signal TX2 in FIG. 9A) separates photodiode MPD from photodiode SPD (e.g., corresponding to photodiode 42 in FIG. 9A).

As shown in FIG. 10, the pinned potential voltage Vpin_spd for photodiode SPD may be at a higher potential than (e.g., may be greater than) the pinned potential voltage Vpin_mpd for photodiode MPD, which is greater than the pinned potential voltage Vpin_1pd for photodiode LPD. This may allow for effective charge transfer from photodiode LPD to photodiode MPD and to photodiode SPD (e.g., during a readout operation) with little time delay. Arrows 78-1, 78-2, and 78-3 show an illustrative readout path for charge at photodiode LPD that passes through photodiodes MPD and SPD to floating diffusion region FD (e.g., when control signals TX1, TX2, and TX3 are fully deasserted).

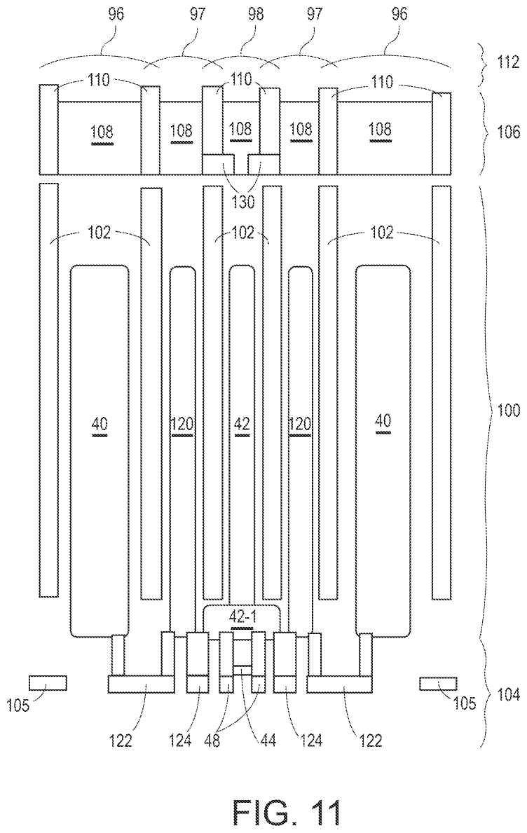

FIG. 11 is a cross-sectional view of an illustrative implementation of an image sensor pixel and corresponding elements described in connection with one or more of FIGS. 9 and 10. The image sensor pixel shown in the cross-sectional view of FIG. 10 may have similar elements as the image sensor pixel shown in the cross-section view of FIGS. 7A and/or 7B. Additionally, the image sensor pixel in FIG. 11 includes medium photodiode 120 (e.g., implemented as a continuous volume) between large photodiode 42 and small photodiode 40. Photodiode 120 may be separated from photodiodes 40 and 42 by isolation structures such as (backside) deep trench isolation structures 102. Color filter array grid 110 may have one or more corresponding openings each aligned with one of photodiodes 40, 120, and 42 and filled with color filter material 108. If desired, the opening for photodiode 42 may be made smaller using light blocking (metal or grid) structures 130, thereby increasing the optical ratio between large photodiode 40 and small photodiode 42. Microlenses 96, 97, and 98 each may also be aligned with a corresponding one of photodiodes 40, 120, and 42. Corresponding transistor structures (e.g., for transistors 48, 124, and 122) may be formed at stack portion 104 to coupled and interconnect photodiodes 40, 120, and 120, and floating diffusion region 44. If desired, the corresponding transistor structures may include vertical portions similar to those shown in FIG. 7B.

Various embodiments have been described illustrating image sensors with high dynamic range pixels each having multiple photodiodes and corresponding in-pixel memory.

As an example, an image sensor pixel may include first and second photosensitive elements (e.g., first and second (pinned) photodiodes), a floating diffusion region, a first charge storage structure (e.g., a first capacitor or first in-pixel memory) coupled to the floating diffusion region, and a second charge storage structure (e.g., a second capacitor or second in-pixel memory) coupled to the floating diffusion region. The second photosensitive element may be coupled between the first photosensitive element and the floating diffusion region. If desired, a third photosensitive element may be coupled between the first and second photosensitive elements.

In particular, a first transistor may couple the first photosensitive element to the first charge storage structure. A second transistor may couple the second photosensitive element to the floating diffusion region. A third transistor may couple the second charge storage structure to the floating diffusion region. A fourth transistor may couple the first photosensitive element to the second photosensitive element. If desired, a plurality of transistors (in parallel) may couple the first photosensitive element to the second photosensitive element. A fifth transistor may couple the first charge storage structure to the floating diffusion region. A reset transistor may couple to the first charge storage structure to a voltage source supplying a supply or reset voltage. A source follower transistor may be coupled to the floating diffusion region. A row select transistor may couple the source follower transistor to a pixel output path.

If desired, the first transistor may form a first charge overflow path for the first photosensitive element, and the second and third transistors may form a second charge overflow path for the second photosensitive element.

If desired, the first pinned photodiode may have a first pinned voltage that is less than a second pinned voltage of the second pinned photodiode. If desired, the first photosensitive element may be disposed around the second photosensitive element. If desired, the first photosensitive element may be formed from (e.g., implemented using) a set of split photodiodes that are coupled to each other and are disposed around the second photosensitive element. If desired, the first photosensitive element may be larger than the second photosensitive element (e.g., the optical (sensitivity) ratio of the first photosensitive element to the second photosensitive element may be greater than one).

If desired, the first charge storage structure may be configured to store a portion of charge (e.g., overflow charge) generated by the first photosensitive element, and the second charge storage structure may be configured to store a portion of charge (e.g., overflow charge) generated by the second photosensitive element.

As another example, an image sensor may include an image sensor pixel array. Each pixel in the image sensor pixel array may include first and second photodiodes, first and second in-pixel memories configured to store first charge generated by the first photodiode and second charge generated by the second photodiode, and a floating diffusion region coupled to the first and second in-pixel memories. If desired, the first photodiode may at least partially and laterally surround the second photodiode, and the first and second in-pixel memories may be implemented as first and second capacitor, respectively.

The foregoing is merely illustrative of the principles of this invention and various modifications can be made by those skilled in the art without departing from the scope and spirit of the invention. The foregoing embodiments may be implemented individually or in any combination.

What is claimed is:

1. An image sensor pixel comprising:
a first photosensitive element;
a second photosensitive element;
a floating diffusion region, the second photosensitive element coupled between the first photosensitive element and the floating diffusion region;
a first charge storage structure coupled to the floating diffusion region; and
a second charge storage structure coupled to the floating diffusion region.

2. The image sensor pixel defined in claim 1, wherein the first photosensitive element comprises a first pinned photodiode having a first pinned voltage and the second photosensitive element comprises a second pinned photodiode having a second pinned voltage that is greater than the first pinned voltage.

3. The image sensor pixel defined in claim 1, wherein the first photosensitive element comprises a first photodiode, the second photosensitive element comprises a second photodiode, and the first photodiode is disposed around the second photodiode.

4. The image sensor pixel defined in claim 3, wherein the first photodiode is formed from a set of split photodiodes that are coupled to each other.

5. The image sensor pixel defined in claim 3, wherein the first photodiode is larger than the second photodiode.

6. The image sensor pixel defined in claim 1, wherein the first charge storage structure is configured to store a portion of charge generated by the first photosensitive element, and the second charge storage structure is configured to store a portion of charge generated by the second photosensitive element.

7. The image sensor pixel defined in claim 6, wherein the portion of charge generated by the first photosensitive element and stored at the first charge storage structure comprises overflow charge generated by the first photosensitive element, and the portion of charge generated by the second photosensitive element and stored at the second charge storage structure comprises overflow charge generated by the second photosensitive element.

8. The image sensor pixel defined in claim 1, wherein the first charge storage structure comprises a first capacitor, and the second charge storage structure comprises a second capacitor.

9. The image sensor pixel defined in claim 1, further comprising:
a first transistor that couples the first photosensitive element to the first charge storage structure.

10. The image sensor pixel defined in claim 9, further comprising:
a second transistor that couples the second photosensitive element to the floating diffusion region; and
a third transistor that couples the second charge storage structure to the floating diffusion region.

11. The image sensor pixel defined in claim 10, wherein the first transistor forms a first charge overflow path for the first photosensitive element, and the second and third transistors form a second charge overflow path for the second photosensitive element.

12. The image sensor pixel defined in claim 10, further comprising:
a fourth transistor that couples the first photosensitive element to the second photosensitive element; and
a fifth transistor that couples the first charge storage structure to the floating diffusion region.

13. The image sensor pixel defined in claim 9, further comprising:
a reset transistor coupled to the first charge storage structure.

14. The image sensor pixel defined in claim 1, further comprising:
a source follower transistor coupled to the floating diffusion region; and
a row select transistor that couples the source follower transistor to a pixel output path.

15. The image sensor pixel defined in claim 1, further comprising:
a third photosensitive element coupled between the first and second photosensitive elements.

16. An image sensor pixel comprising:
a first photodiode;
a second photodiode, the first photodiode disposed around the second photodiode;
a floating diffusion region coupled to the second photodiode;
a first charge storage structure coupled to the first photodiode; and
a second charge storage structure coupled to the floating diffusion region.

17. The image sensor pixel defined in claim 16, wherein the first photodiode comprises a set of split photodiodes coupled to each other and each disposed around the second photodiode.

18. The image sensor pixel defined in claim 16, further comprising:
a plurality of transistors that couple the first photodiode to the second photodiode.

19. An image sensor comprising:
an image sensor pixel array, each pixel in the image sensor pixel array including:
first and second photodiodes,
first and second in-pixel memories configured to store first charge generated by the first photodiode and second charge generated by the second photodiode, and
a floating diffusion region coupled to the first and second in-pixel memories.

20. The image sensor defined in claim 19, wherein the first photodiode at least partially and laterally surrounds the second photodiode, and the first and second in-pixel memories are first and second capacitor, respectively.
